(19) United States
(12) Patent Application Publication
(10) Pub. No.: US 2011/0056376 A1
(43) Pub. Date: Mar. 10, 2011

(54) LOW COST COMPOSITE DISCHARGE ELECTRODE

(75) Inventor: Hajrudin Pasic, Athens, OH (US)

(73) Assignee: OHIO UNIVERSITY, Athens, OH (US)

(21) Appl. No.: 12/668,210

(22) PCT Filed: Jul. 14, 2008
(86) PCT No.: PCT/US2008/069957

§ 371 Date: Jan. 8, 2010

Related U.S. Application Data
(60) Provisional application No. 60/949,283, filed on Jul. 12, 2007.

(51) Int. Cl. B03C 3/41

(52) U.S. Cl. 96/97

(57) ABSTRACT

A the discharge electrode made of at least two parts. One part is the mast, which is made from substantially non-electrically conductive material, such as a CPVC pipe. The second part is a spike-carrying elongated member, such as a wire, made of substantially electrically conductive material, with sharpened spikes extending from the wire. The spike-carrying elongated member is attached to the mast, such as by winding around the mast in a helical pattern, and connected to an electrical device. The spikes extend away from the mast.

### BACKGROUND OF THE INVENTION

1. Field of the Invention

This invention relates generally to an electrostatic cleaning apparatus for removing particulate from a gas stream, and more particularly to a discharge electrode construction for an electrostatic cleaning apparatus.

2. Description of the Related Art

Discharge electrodes are typically used in electrostatic precipitators and filters and in other devices. Discharge electrodes are used to charge, under high voltage, electrically neutral particulate matter that is found in a gas stream in order to polarize the particulate so that it can be filtered out. For example, a discharge electrode is used in an electrostatic precipitator to polarize the particulate, which is then collected on an oppositely charged electrode. This is shown in U.S. Pat. No. 6,231,643 to Pasic et al., which is incorporated by reference herein.

Typically, discharge electrodes operate in harsh, chemically-aggressive environments, especially in wet electrostatic precipitators. Because of the destructive characteristics of these environments, very expensive materials must be used for fabrication of the discharge electrodes so that the electrodes last for a sufficient period before becoming so corroded, worn and otherwise damaged that they are not functional.

Conventional discharge electrodes are thin, electro-conductive wires or thin, twisted rods or tapes with sharp edges. The sharp edges are necessary to produce corona discharge at high enough voltage to ionize the initially neutral particles that are to be filtered out from the “dirty” gas stream. However, mechanical strength and durability are key factors to a workable discharge electrode. Furthermore, discharge electrodes must function over a long period of time without maintenance requirements. Most conventional discharge electrodes have a stiff cylindrical rod or pipe with sharp protruding spikes along the mast to provide the mechanical support while still having sharp edges needed for corona discharge.

Electrodes used in electrostatic precipitators typically range in length from about 6 to 10 feet in vertical-flow wet precipitators. In vertical-flow wet precipitators, the discharge electrodes are set in the middle of vertical channels, which can be circular or square in cross section, and the gas carrying the particulate to be charged flows upward, along the length of the electrode, at velocities of about 5 to 10 feet/second (fps or ft/s).

The discharge electrodes are typically up to about 30 feet long in horizontal-flow dry and wet precipitators. In horizontal-flow precipitators, vertical discharge electrodes are set between vertical collector plates while particulate-laden gas flows horizontally between the plates at speeds of about 3 to 6 fps. Unlike vertical-flow precipitators, in which the gas flows along the electrodes, in horizontal-flow precipitators the gas flow is perpendicular to the electrodes and therefore can cause severe flow-induced vibrations and deflections of electrodes even at low gas velocities. These vibrations must be suppressed because vibrations can cause sparking between charged electrodes' spikes and grounded collection plates if the distance between the two is reduced below a critical value at a given applied voltage. Therefore, the discharge electrodes must be stiff enough to resist substantial vibration-induced deflection.

Based on the preceding, it is clear that the requirements to be satisfied by discharge electrodes vary by the application. For example, electrodes used in vertical-flow wet precipitators are more exposed to chemical corrosion and are less prone to vibration, while the opposite is true with electrodes used in horizontal dry-flow precipitators.

It is typical to make a one-piece discharge electrode mast from a metal rod or a pipe about 1.5 inches in diameter. Spikes are typically welded in a radially extending orientation with spaces between the spikes of 2 to 4 inches. Spikes have various dimensions and shapes, and most often in conventional discharge electrodes the spikes resemble sharp nails that are 1 to 1.5 inches long and extend in radial directions from the pipe's outer surface. Frequently, especially in wet precipitator applications, spikes have the form of so-called “ninja stars”, which resemble the well-known throwing weapons used in martial arts. A ninja star is formed by making a plurality of arcuate cuts along the peripheral edge of a thin metal disc. The end of each arcuate cut intersects the end of the next adjacent cut, thereby producing 6 to 8 sharp corners (which function as spikes) on the disc's peripheral edge as described and shown in International Patent Application Publication No. WO2006/113749 to Alam, which is incorporated herein by reference. The ninja stars can have an outer diameter of 1.5 to 2 inches at the tips, and can be welded every 2 to 4 inches along the mast.

In less corrosive environments, such as in dry precipitators, a common practice is to make robust one-piece electrodes of low-carbon steel. In wet precipitators, a common electrode is made from corrosion-resistant stainless steel, such as SS316. In many severely corrosive, and/or erosion prone environments, such as in some wet precipitators where the less expensive iron-based alloys and even stainless steels tend to fail, nickel-based “super alloys”, such as Hastelloy C276 and the like must be used. These electrodes are prohibitively expensive, primarily because of the cost that is associated with the electrode's mast.

Many patents propose discharge electrodes made of two or more parts, such as U.S. Pat. Nos. 3,819,985, 3,966,436, 4,042,354, 4,247,307, 4,389,225. These patents tend to suggest that the mast and the spikes be made of the same, electro conductive material. Therefore, the need exists for a discharge electrode that has a low cost, but nevertheless is able to survive the environment in which it is placed.

### BRIEF SUMMARY OF THE INVENTION

The purpose of this invention is a new electrode preferably made of two or more parts selected according to the environment, thereby making the electrode cost-effective and able to withstand chemically aggressive environments. The preferred electrode provides high corona power, and its design allows for easy variations in a given electrode's dimensional properties in order to alter the discharge characteristics for a particular set of circumstances.

In the most preferred embodiment of the invention, the discharge electrode is made of two or more parts. One part is the mast, which is preferably made from inexpensive material that is not necessarily electrically conductive. The second part is a spike-carrying elongated member, such as a ribbon, wire or rib, made of electrically conductive material. The spike-carrying elongated member is attached to the mast, such as by winding around the mast in a helical pattern, and connected to an electrical device that applies a voltage between the spike-carrying elongated member and another member electrically connected to the device. The spike carrying elongated member is not necessarily expensive, corrosion-resistant material, but can be. However, by virtue of the fact that the elongated member is a relatively small portion of the electrode, even if it is made of expensive material, the cost of the entire electrode will not be substantial compared to conventional electrodes made entirely of the expensive material.

The spike-carrying elongated members described herein can be cost-effectively produced even from expensive materials, such as Hastelloy and other similar superalloys. By combining such members with an inexpensive mast, the resulting combination has the performance of a conventional discharge electrode without the cost of those electrodes made entirely of expensive material.

Plastic-like electro conductive composite materials are also advantageous for the invention. For example, carbon powder-filled low-cost electro conductive materials with excellent electrical stability, abrasion and crack-resistance, high impact strength and good chemical resistance can be used to make the spike-carrying elongated members. These materials are lightweight, easily machined and commonly produced as sheets. They cannot readily be helically wound about a mast due to their thickness, but they can readily be cut from a sheet to produce seesaw-shaped slats with spikes and adhered, or mechanically attached, to the mast as shown in FIG. 8.

In summary, the composite discharge electrode can be designed in a number of different ways and from a variety of different materials. The number of these arrangements is virtually unlimited. The spike-holding substrates (strips, slats, etc.) can also be mounted in numerous other ways, not only in a helical, circumferential or longitudinal configuration. Also, the electrode mast does not have to have a circular cross section; it can even be a long and narrow rectangle parallel to collection electrodes of an electrostatic precipitator. A person of ordinary skill will understand that other designs and materials can be substituted for these designs and materials. However, what is most important is that the electrode is made of two or more parts. The mast is made of inexpensive, standard stock material, which is preferably not substantially electrically conductive. The spike-carrying strip is made of substantially electrically conductive material.

The composite discharge electrode has a flexible design. Mast diameters and the spike lengths can be readily varied to change the corona power and charging efficiency, if necessary. For example, if the gas to be cleaned contains a large amount of submicron particles, such as at the inlet, the so-called “corona suppression” may occur. This is not the case near the outlet. In electrostatic precipitators, it is desirable to maintain a uniform electric field and in vertical-flow precipitators, for example, the discharge characteristics sometimes need to be changed even along each single electrode. The mast has a smaller diameter and the spikes are longer at the bottom while the opposite is true at the top of the electrodes. In a horizontal-flow precipitator, the geometry of discharge electrodes, although uniform along each single electrode, is different at the precipitator's inlet than at the outlet. The invention provides the needed ability to vary the electrodes' configuration at any given point. Indeed, one can even take existing electrodes, disassemble them and re-assemble them to have a different configuration more suited to the circumstances. This flexibility permitted by the modular feature of the discharge electrode is very desirable.

### BRIEF DESCRIPTION OF THE SEVERAL VIEWS OF THE DRAWINGS

FIG. 1 is a side view illustrating an embodiment of the present invention in which a circular cylindrical mast has a spike-carrying wire wrapped around it in a helical configuration.

FIG. 2 is a side view illustrating a spike-carrying elongated member for another embodiment of the present invention.

FIG. 3 is a top view illustrating another embodiment of the present discharge electrode invention.

FIG. 4 is a top view illustrating another embodiment of the present discharge electrode invention.

FIG. 5 is a view in perspective illustrating another embodiment of the present invention.

FIG. 6 is a top view illustrating another embodiment of the present invention.

FIG. 7 is a view in perspective illustrating another embodiment of the present invention.

FIG. 8 is a side view illustrating another embodiment of the present invention.

FIG. 9 graphically illustrates experimental test results of one embodiment of the present invention and three conventional discharge electrodes.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### DETAILED DESCRIPTION OF THE INVENTION

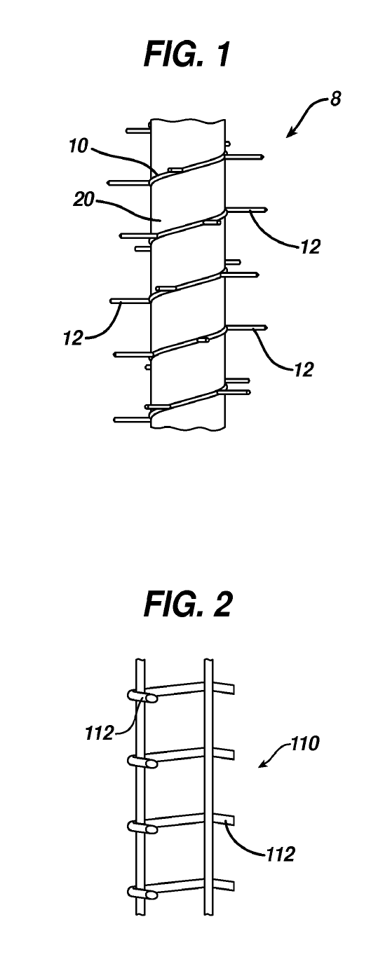

A discharge electrode 8 in accordance with the present invention is shown in FIG. 1. A spike-carrying elongated member 10 is wound helically along the mast 20 of the electrode 8. The member 10 can be attached to the mast 20 in some other configuration, and some examples of other configurations are disclosed herein. Of course, the person having ordinary skill will understand from the disclosure herein that other configurations are possible, even though such other configurations are not described expressly herein.

The mast 20 of the discharge electrode 8 is preferably a tube that has a continuous or non-continuous passage within its outer wall, or a solid bar having a circular cross section. Of course, other cross sections are contemplated, including without limitation, oval, virtually any polygon and irregular shapes. In a wet precipitator application, the mast 20 is preferably a 1.5 to 2 inch diameter, thick-walled, chlorinated polyvinyl chloride (CPVC) pipe, or a pipe made from other similar inexpensive and not substantially electrically conductive materials. The term “substantially electrically conductive” and similar terms are defined herein to mean materials that contain electric charges which move when an electric potential difference is applied across separate points on the material. These include, but are not limited to, solids, such as metals and graphite. “Substantially non-conductive materials” and similar terms are defined herein to mean materials that contain few electric charges which move when an electric potential difference is applied across separate points on the material. These include, but are not limited to, insulators.

CPVC pipes and rods have excellent corrosion resistance at elevated temperatures, and are essentially inert to attack by a wide variety of strong acids, alkalis, salt solutions, and many other chemicals. They are dependable in corrosive applications, and do not readily react with materials in contact. CPVC can be connected to metals, is immune to galvanic or electrolytic action, and resists abrasive wear well.

The pipe of the mast 20 can be cut to any length desired. The mast 20 can be made from other standard stock materials, including composites such as fiberglass and other relatively strong materials that resist damage from various chemicals encountered in electrostatic precipitators. The mast 20 should also be made from a material that is stable at the corresponding temperatures, which are about 130° F. in wet precipitators and 320° F. in dry precipitators. The material must also resist abrasion and be inexpensive compared to materials used in the existing one-piece electrode designs of the prior art. In most applications, CPVC pipes should perform satisfactorily. As an example, such pipes can be one order of magnitude lower in cost than superalloys such as Hastelloy.

The elongated member 10 is a spike-carrying wire that is made of electrically conductive material, including without limitation, stainless steels and superalloys. As is conventional for such electrodes, the elongated member 10 is electrically connected to an electrical device that places the elongated member at a different electrical potential than another structure, such as a collecting electrode, that is also electrically connected to the electrical device. The spikes 12 on the wire are preferably made of the same material as the wire, but this is not necessary. Stainless steels and superalloys resist damage due to corrosion and abrasion, and posses the necessary mechanical strength at the operating temperatures commonly encountered in electrostatic precipitators to permit them to perform the required function of the spikes 12. With the invention, the total cost of the electrode is considerably reduced since only the member 10 needs to be made of expensive material.

The spike-carrying elongated member 10 has a base or substrate that can be one of a variety of shapes and dimensions and may be made of a large number of electro-conductive materials. For example, the base or substrate is preferably a wire having a round cross-section, but a wire of virtually any cross section will suffice as long as it retains the strength necessary and the ability to attach to the mast 20. Thus, ribbons, which are substantially wider than they are thick, can be used. Additionally, braided strands of material can also be used.

An alternative way of producing an elongated member is to utilize the widely available welded wire meshes to form a strip with spikes 110 as shown in FIG. 2. Wire meshes are essentially heavy screen material woven from wires that intersect and are welded or otherwise adhered at the points of intersection. The opening size and shape of the mesh depend on applications and may vary significantly. In electrostatic precipitator applications, an example of the aperture sizes in mesh is between about 1 and 2 inches square. Another example has rectangular mesh openings that are 1 by 2 inches. Examples of wire diameter include about 0.06 to about 0.105 inches. Such screens are commonly available in 3 or 4 feet wide rolls that are normally 100 feet long.

The strip with spikes 110 can be made by longitudinally slitting or cutting the wire mesh with the width of the strip equal to the desired distance between the spikes. Spikes 112 are formed by the wires that make up the mesh being cut to have a free end as shown in FIG. 2. The strip 110 can be one or more wire mesh openings wide. The length of the spikes 112 on opposite sides of the strip 110 is substantially equal to the width of the mesh openings, such as one inch. The spikes 112 are bent to a desired angle, preferably 90 degrees to the plane of the wires that define the mesh openings, and sharpened, such as by a conventional metal grinder. The shearing and sharpening operations may be combined into one by using an angled die with the screen fed through the die or by a rotary-type shear with two round dies that overlap each other, thereby creating a shearing action.

Winding the strip 110 on a mast, which can be the same as the mast 20 of the FIG. 1 embodiment, can be performed manually or by using machinery. One way to accomplish this is to use a lathe in which one end of the mast is clamped in a slowly rotating lathe jaw. The opposite end of the rotating mast is simply supported and free to rotate. One end of the strip with spikes 110 is firmly attached at one end of the mast by a screw and a washer, which washer has a small hole that slides down over the first spike on the strip 110. The screw is then driven into the mast. Of course, adhesives, welds or any other equivalent attachment can be used. The strip 110 is wound on the mast by keeping it in tension and at a constant angle with respect to the mast, in order to keep a constant pitch, while the mast is rotated. This causes the side of the strip 110 opposite the spikes 112 to abut the mast in a helical pattern in the manner of screw threads. The spikes 112 preferably point radially outwardly of the cylindrical mast along a helical path around the mast.

The strip 110 can be fed through a tube guide that rides on a carriage and holds some tension against the winding strip, and this is particularly desirable in an automated machine. As the lathe is started, this guide and carriage advance parallel to the mast and away from the head stock towards the tail stock at the desired constant speed. The strip 110 is attached at least near the tail stock, or more preferably at various points along the length of the strip 110, such as by additional screw/washer combinations, welds, adhesives or any other suitable fastener.

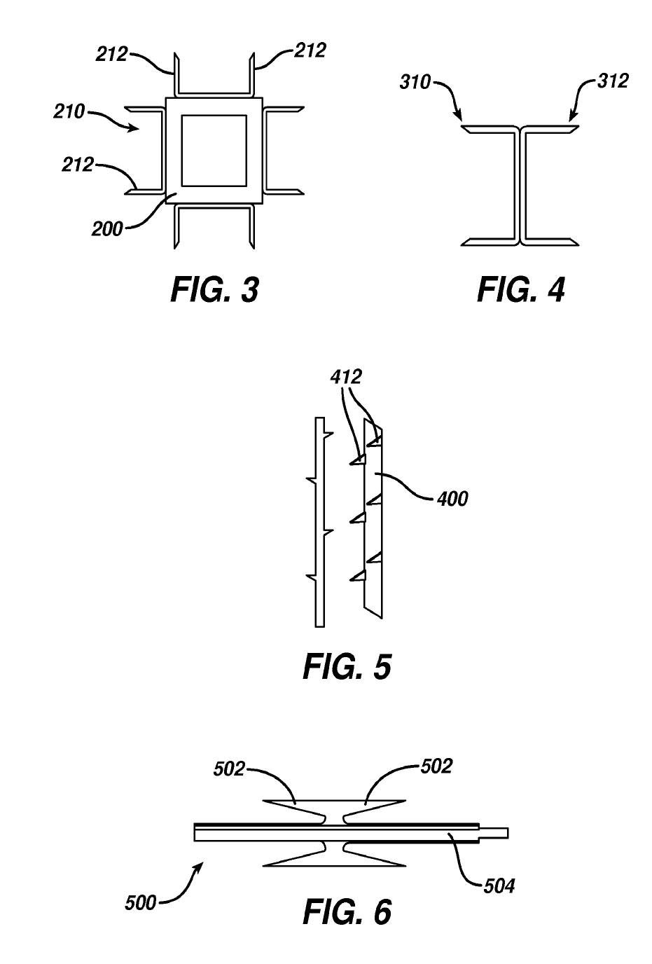

A similar wire-mesh strip 210 can be attached to a noncircular pipe mast, such as the square pipe 200 shown in FIG. 3, with the spikes 212 facing outwardly, or to a base of any shape material that can provide the structural rigidity necessary. In an embodiment, which is not illustrated, the four sets of wire-mesh strips are mounted at intersecting corners as in FIG. 3, but fastened to one another rather than to a pipe. Thus, the wire-mesh strips serve to reinforce one another and support the spikes. In another embodiment of the invention, shown in FIG. 4, two wire mesh strips 310 and 312 are mounted to each other, without using any mast, and provide sufficient mechanical support to form an electrode.

Another contemplated configuration for an elongated member having spikes extending therefrom is a thin metal strip 400, as shown in FIG. 5. The strip 400 is, for example, about one-half of inch wide, and sharpened members are attached to or formed integral with the strip 400. These members are bent perpendicular to the strip 400, to form spikes 412. The spikes can have a variety of shapes and dimensions.

Another alternative solution to producing specialized elongated strips with spikes is to use so-called “concertina” barbed wires manufactured by many companies, such as Cobra Manufacturing Inc., Lake Katrine, N.Y. Such barbed wire can be made of advantageous corrosion and abrasion-resistant materials, or existing material barbed wires can be used in some circumstances. The blades 502 of the concertina barbed wire 500 are shown in FIG. 6, and typically have about one-inch long, very sharp spikes parallel to the wire 504. The blades 502 are mounted to the wire 504 by pressure rolling every 4 to 6 inches. The blades 502 are made by shearing a thin stainless steel sheet. The diameter of the wire 504 is about 2-3 mm. The blades 502 need to be bent about 90 degrees relative to the wire 504, and then the barbed wire 500 is wound around an electrode mast, such as a mast substantially identical to the mast 20 of FIG. 1. It is clear that the same technology may be used to produce a variety of blades and/or spikes with different geometries and made of various kinds of materials.

Another alternative embodiment uses spikes attached to a sheet metal band, which is then attached to a mast. The band is preferably made of the same material as the spike, and the band is preferably a ribbon of thin metal that has substantially the same inner diameter as the outer diameter of the mast. Spikes are stud-welded to the band preferably before the band is wound about the electrode mast. A plurality of such bands are electrically connected together and to an electrical device that places the spikes and the bands at an electrical potential different than another electrode.

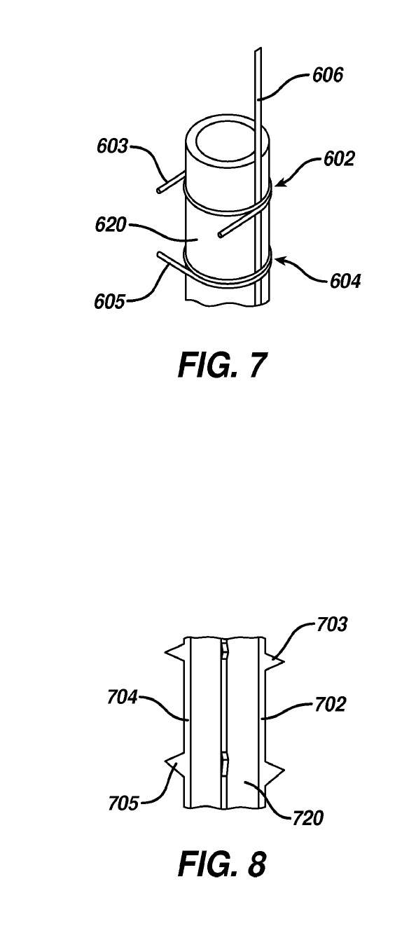

Yet another alternative embodiment is shown in FIG. 7, in which sharpened torsion springs 602 and 604 are mounted with an electro conductive band 606 between them and the mast 620, if the mast is made of a nonconductive material. Spikes 603 and 605 are formed at the sharpened ends of the springs 602 and 604, respectively. As the spikes of each spring are pushed relative to each other, the diameter of the circular springs can be increased so that the spring can be slid onto and moved longitudinally along the electrode mast. Upon release, the springs tighten, thereby pressing against the conductive band 606. If the characteristics of the springs 602 and 604 are selected strategically, the tightening force applied by the springs to the conductive band 606 and the mast 620 is sufficient to cause the springs 602 and 604 to grip the mast 620 tightly, thereby preventing longitudinal movement relative to the mast 620. FIG. 7 shows only one of a variety of spring and spike designs in terms of their length and the angle with respect to each other, and the wire thickness. Of course, other alternatives are possible.

Other contemplated embodiments that are not illustrated include substantially a non-conductive plate (planar mast) with elongated, spike-carrying members extending around in a helical pattern, and alternatively in a circumferential pattern. Still further, elongated, spike-carrying members can be extended through the interior passage of a substantially non-conductive tube and around the outside of the same. This can be done in a helical pattern or in a plurality of loops.

Yet another alternative embodiment is shown in FIG. 8, which illustrates long and relatively narrow “seesaw” ribs 702 and 704 that are about ⅛″ thick rectangular wires. The ribs are 702 and 704 are attached longitudinally or in some other convenient pattern to the electrode mast 720, such as by welding or adhesive, with spikes 703 and 705 protruding in radial directions from the circular cross-section mast 720. The ribs 702 and 704 are then connected to a conventional high voltage source (not illustrated), as with all of the other electrically conductive elongated members described above.

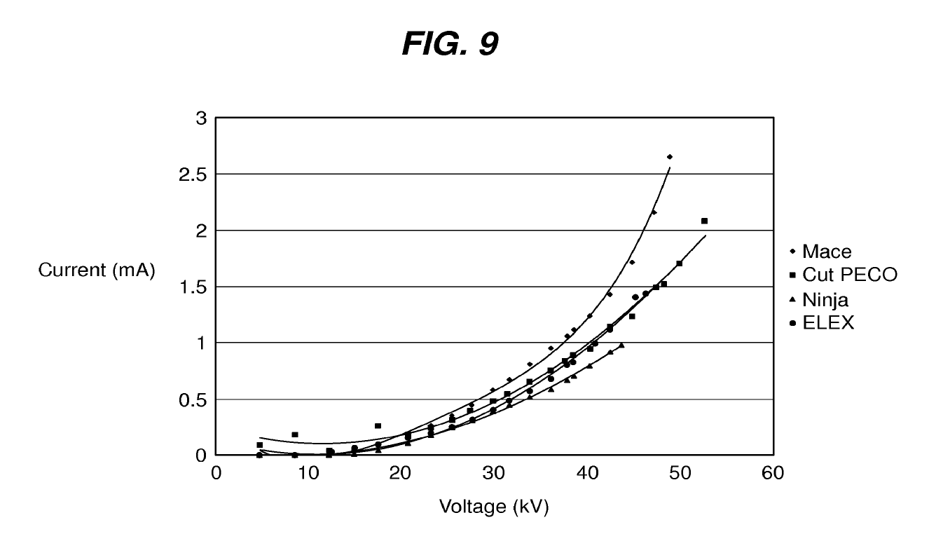

A number of tests conducted on composite discharge electrodes confirm that the invention has substantial merit and utility. In tests performed, the corona current (i) was measured as a function of DC voltage (V) applied. The results of the test of an embodiment of the invention are compared with three other commonly used electrodes in FIG. 9.

The first conventional electrode tested, referred to as ELEX, is produced by SEI Inc., Pensacola, Fla. It is made in one piece from sheet metal. Its mast has the form of a pipe with a diameter of 1.5 inch. The spikes extend outwardly on both sides of the mast and the overall radial distance between their tips is 4.5 inches. The distance between spikes on each side of the mast, along its length, is 3.5 inches. The spikes on the two sides of the mast are staggered.

The second tested electrode, referred to as a “Ninja star” in FIG. 9, is also produced by SEI Inc. It is a wafer-like thin disc with eight sharp corners produced by stamping out eight arcuate sections along the 2-inch wafer's circumference and which touch each other to form the spikes. The discs are mounted on a 1.5-inch metal tube and welded to it spaced 2 inches apart along its length.

The third standard electrode tested is produced by PECO-FGC Inc, Westlake, Ohio, and is referred to as “Cut PECO” in FIG. 9. Its V-shape spikes are welded on opposite sides of a 1.5-inch pipe.

The fourth composite electrode, referred to as “Mace” in FIG. 9, was manufactured according to the invention, and in relation to the discussion herein relating to FIGS. 1 and 2. The elongated member was formed by cutting a strip from a welded wire mesh sheet with 1 inch openings, and a wire diameter of 0.08″. The wires were cut along the sheet in the middle of two rows of openings leaving a full opening between them, to produce a 2 inch wide strip. The 0.5 inch long spikes were produced by bending wires on the two sides of the strip as shown in FIG. 2. The elongated member was then helically wound with a 2 inch pitch on a standard CPVC 2 inch diameter pipe. The outer diameter of the electrode, from the tip of one spike to the tip of the opposite spike, was about 3 and ⅛ inches.

Another composite electrode was made in accordance with the invention and tested was manufactured by using two strips identical to those in the Mace electrode but without a substrate, as shown in FIG. 4. The strips were pin-welded to each other with spikes facing away from one another. The test results were found to be identical to those obtained with the Mace electrode. This electrode can possibly be a very efficient solution provided that it is properly kept straight by a heavy weight hanging at its bottom. Another option is to pin-weld the two wire mesh strips to a rigid substrate between them.

The testing rig consisted of a grounded 1 foot wide by 1 foot thick by 3 feet tall vertically oriented box made of thin sheet metal. A vertically oriented, 3 feet long discharge electrode was disposed in the middle of the box, held by insulating frames at its bottom and top and spanning the space between the electrode and the box. In all electrodes tested, each electrode had spikes installed only on each electrode's 2 feet long central portion. That is, about 6 inches at the top and bottom of the electrode had no spikes.

For the one-piece conventional electrodes, voltage was applied to the whole electrode. In the case of the two-piece electrode constructed according to the invention, voltage was applied to the elongated member with spikes. The voltage was gradually increased from zero to the value that caused sparking, at which point the voltage was stopped and the voltage and current measurements that caused sparking were recorded. All tests were conducted at room temperature and in still air. The test results are presented in FIG. 9. Clearly, the composite Mace electrode outperformed all others in the relevant voltage range.

Discharge electrodes are normally suspended and clamped at an upper end on a high voltage insulator beam and, if they are relatively long, they are centered by means of an adjustable guide frame at their lower end in order to stiffen them. The guide frame at the bottom consists of adjustable tie rods. In order to suppress vibrations and to make them as stiff as possible, longer electrodes need to be clamped at the top and at the bottom, i.e., at the guide frame. This mitigates or eliminates lateral deflections and electrodes' rotations at those points. If necessary, additional stiffening can be accomplished by suspending weights attached to the lower end, as is often done in all kinds of conventional precipitators.

A simple calculation shows that the lowest natural frequency of a 10-foot composite electrode made of standard CPVC Schedule 80 pipe with the outer diameter of d=2.375 inches and thickness of 0.218 inches, clamped at both ends, is f=0.56\sqrt{EI/mL⁴}=1.31 Hz; where E, I, m, L are Young's modulus, moment of inertia, mass per unit length and pipe's length, respectively. The lowest critical gas speed across the electrode to cause dangerous vortex-shedding vibration is therefore found to be V_{C}=fd/Sₜ=0.41 m/s, where Sₜ=0.2 is the Strouhal number (see R. D. Blevins: “Flow-induced Vibration”, Van Nostrand Reinhold, New York, 1990). The second natural frequency and the corresponding critical flow speed far exceed the value met in electrostatic precipitators.

At this speed the maximum mast electrode vibration amplitude is Aₘ=Cₗρd³/(16π²Sₜ²mξ), where Cₗ≈1 is the lift coefficient, ρ is gas density, m is the mass of the mast per unit length and ξ is the damping coefficient (see R. D. Blevins: “Flow-induced Vibration”, Van Nostrand Reinhold, New York, 1990). Tests were conducted to find that the damping coefficient for the CPVC pipe is ξ=0.03. With unit mass m=1.4 kg/m one finds that the maximum pipe deflection due to vortex shedding at the critical gas speed of 0.41 m/s is Aₘ=0.86 mm.

The corresponding maximum static deflection of the pipe at the same gas velocity can easily be found from the well known formula Aₛ=ql⁴/(384EI), where the total load on the pipe exerted by the gas q=ρdC_{d}lV_{c}²/2, where C_{d}≈1 is the drag coefficient and l is the pipe length (see J. E. Shigley and L. D. Mitchell: “Mechanical Engineering Design”, McGraw Hill, 1983). It is found that Aₛ=4.9×10⁻³ mm, i.e. it is negligible compared to the vortex-induced vibration amplitude.

Even if the gas velocity is increased tenfold, the pipe static deflection will be negligible with respect to the deflection caused by flow-induced vibration. Hence it is important to suppress those vibrations. In this respect, the composite electrode should outperform conventional electrodes since helical strakes, axial slats, and other kinds of fins are normally installed on the top of tall and slender vibration-prone structures such as chimneys, communication towers etc. in order to suppress flow-induced vibrations (see R. D. Blevins: “Flow-induced Vibration”, Van Nostrand Reinhold, New York, 1990). Namely, these structures help spoil a regular vortex formation along the mast, which causes the resonance.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. An electrode comprising:
(a) a mast made of substantially non electrically-conductive material; and
(b) an elongated body mounted to the mast with a plurality of spikes extending from the elongated body with a component extending away from the mast, the elongated body and the spikes being made of substantially electrically conductive material.

2. The electrode in accordance with claim 1, wherein the elongated body comprises a strand of metal wire wound helically around and seating against the mast, the strand of metal wire having a plurality of shorter spikes, each of said plurality of spikes rigidly attaching to the strand of metal wire at a spike end proximal to the mast and extending to an opposing spike end distal from the mast.

3. The electrode in accordance with claim 2, wherein the strand of metal wire comprises a plurality of strands of metal wire connected to one another.

4. The electrode in accordance with claim 2, wherein each of said plurality of spikes comprises a blade.

5. The electrode in accordance with claim 1, wherein the elongated body comprises a strand of metal wire seating against the mast, the strand of metal wire having a plurality of blades, each of said plurality of blades rigidly attaching to the strand of metal wire at a spike end proximal to the mast and extending to an opposing blade end distal from the mast.

6. The electrode in accordance with claim 1, wherein the elongated body comprises a plurality of strands of metal wire connected to one another and seating against the mast, the strands of metal wire having a plurality of shorter spikes, each of said plurality of spikes rigidly attaching to the strands of metal wire at a spike end proximal to the mast and extending to an opposing spike end distal from the mast.

7. The electrode in accordance with claim 6, wherein the mast is elongated and the plurality of strands of metal wire extend substantially along the length of the mast.

8. The electrode in accordance with claim 1, wherein the elongated body comprises a metal ribbon seating against the mast, the ribbon having a plurality of spikes, each of said plurality of spikes rigidly attaching to the ribbon at a spike end proximal to the mast and extending to an opposing spike end distal from the mast.

9. The electrode in accordance with claim 1, wherein the elongated body comprises:
(a) a first metal band seating against the mast and encircling the mast at one position on the mast, the band having a plurality of spikes, each of said plurality of spikes rigidly attaching to the band at a spike end proximal to the mast and extending to an opposing spike end distal from the mast;
(b) a second metal band seating against the mast and encircling the mast at a spaced, second position on the mast, the second metal band having a plurality of spikes, each of said plurality of spikes rigidly attaching to the second metal band at a spike end proximal to the mast and extending to an opposing spike end distal from the mast; and
(c) a substantially conductive member in electrical contact with the first metal band and the second metal band.

10. The electrode in accordance with claim 1, wherein the elongated body comprises:
(a) a first torsion spring seating against the mast and encircling the mast at one position on the mast, the first spring having a plurality of spikes, each of said plurality of spikes rigidly extending integrally from the first spring at a spike end proximal to the mast and extending to an opposing spike end distal from the mast;
(b) a second torsion spring seating against the mast and encircling the mast at a spaced, second position on the mast, the second spring having a plurality of spikes, each of said plurality of spikes extending integrally from the first spring at a spike end proximal to the mast and extending to an opposing spike end distal from the mast; and
(c) a substantially conductive member in electrical contact with the first spring and the second spring.

11. A method of making an electrode, the method comprising the steps of:
(a) mounting an elongated body made of substantially electrically conductive material to a mast made of substantially non electrically-conductive material; and
(b) extending a plurality of spikes made of substantially electrically conductive material from the elongated body with a component away from the mast.

12. The method in accordance with claim 11, wherein the step of mounting the elongated body comprises helically winding the elongated body around the mast and seating the elongated body against the mast.

13. The method in accordance with claim 12, wherein the step of helically winding the elongated body further comprises feeding the elongated body through a gate to the mast, while rotating the mast.

14. The method in accordance with claim 11, wherein the step of mounting the elongated body comprises circumferentially winding the elongated body around the mast and seating the elongated body against the mast.

15. The method in accordance with claim 11, wherein the step of mounting the elongated body comprises expanding the elongated body, extending the elongated body around the mast and then releasing the elongated body to contract, thereby seating the against the mast.

16. An electrode comprising:
(a) a first member having at least two substantially parallel metal wires made of substantially electrically-conductive material, a plurality of transverse wires made of substantially electrically-conductive material extending between said at least is formed from an extension of one of said transverse wires and made of substantially electrically-conductive material; and
(b) a second member having at least two substantially parallel metal wires made of substantially electrically-conductive material, a plurality of transverse wires made of substantially electrically-conductive material extending between said at least two substantially parallel metal wires and a plurality of spikes, wherein each spike is formed from an extension of one of said transverse wires and made of substantially electrically-conductive material
wherein the second member is mounted to the first member and is electrically connected thereto.
